(19) United States
(12) Patent Application Publication
(10) Pub. No.: US 2019/0368249 A1
(43) Pub. Date: Dec. 5, 2019

(54) S overlay jig

(71) Applicants: David Alexander Liddle, Round Rock, TX (US); Justin Allen Liddle, Murfreesboro, TN (US)

(72) Inventor: Jeffrey Brian Liddle, Mt Juliet, TN (US)

(21) Appl. No.: 15/996,452

(22) Filed: Jun. 2, 2018

(51) Int. Cl. E05D 7/10; E05D 5/02

(52) U.S. Cl. CPC E05D 7/10; E05D 2007/1094; E05Y 2900/20; E05D 5/0276

(57) ABSTRACT

The invention is an apparatus intended to aid in the installment of the Salice Overlay hinge mounting plate onto cabinets; the use of this invention will be most relevant to the custom cabinetry industry. The invention will be used to provide consistency and accuracy in mounting plate placement on custom cabinets, thereby ridding the industry of mistakes inherent in the installation of Salice cabinet hardware by hand.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention is applicable to the field of custom cabinetry. Without the use of this invention, cabinet makers must install Salice Overlay hinge hardware by individually measuring the height from the base and depth from the face of a cabinet to which the mounting plate is to be fastened. This process is timely and prone to improper hinge placement.

### BRIEF SUMMARY OF THE INVENTION

The invention is designed to securely hold the Salice Overlay hinge mounting plate in the desired position inside of a cabinet while the user fastens the plate to the cabinet. Adjustable guide rails above and below the plate, for dexterity, keep the plate at a fixed height inside the cabinet. An immovable, rigid edge lays against the face of the cabinet, creating a fixed depth for the mounting plate. The shape of the invention keeps the fastening positions on the mounting plate free of obstruction, allowing the user to fasten the mounting plate to the cabinet without having to remove it from the invention.

### BRIEF DESCRIPTION OF THE SEVERAL VIEWS OF THE DRAWING

1. FIG. 1

Depicts the invention, with guide rails (details (a) and (b)) in place, but unsecured. The center portion of the main body (detail (c)) is specifically designed to fit the Salice Overlay hinge mounting plate.

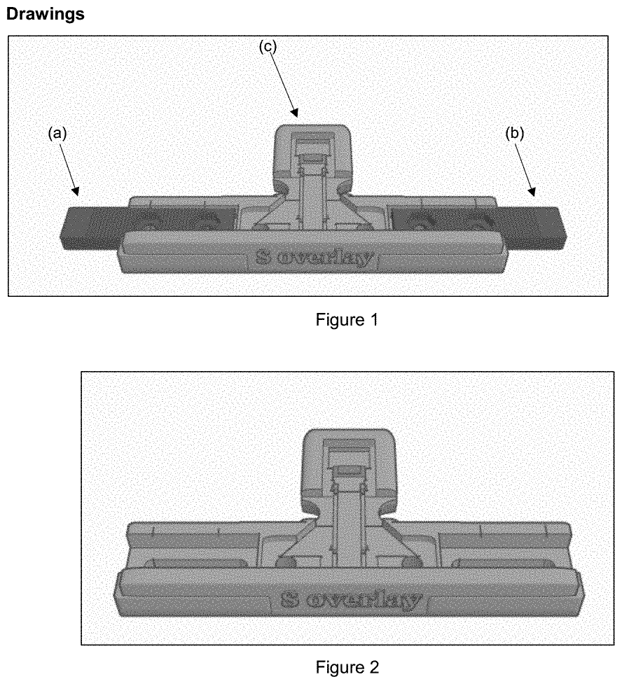

2. FIG. 2

Depicts the invention without the guide rails in place.

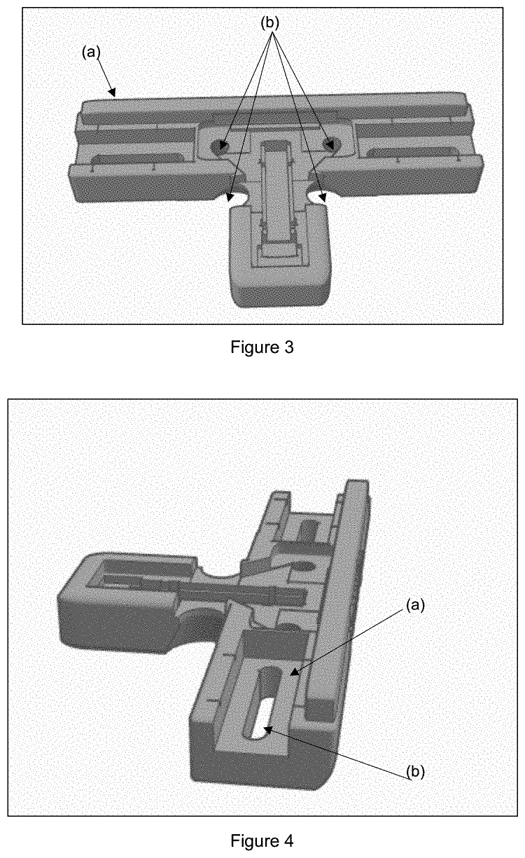

3. FIG. 3

Depicts a rotated view of the invention where the rigid edge that positions the mounting plate flush to the face of the cabinet (detail (a)) and the contours of unobstructed fastening positions (detail (b)) can be seen.

4. FIG. 4

Depicts a side view of the invention, without the guide rails, to show the recessed tracks for the rails (detail (a)) and the hollowed-out tracks for the bolts that secure the rails into position (detail (b)).

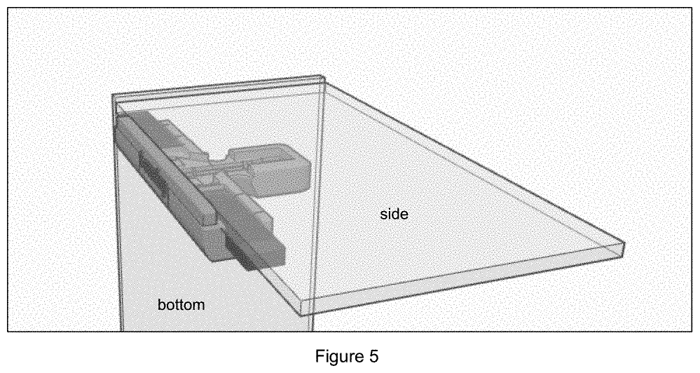

5. FIG. 5

Depicts the invention and how it is placed onto a cabinet to aid in the installment of the Salice Overlay hinge mounting plate.

### DETAILED DESCRIPTION OF THE INVENTION

The invention is designed using computer animated design software to fit exactly to the shape and contours of the Salice Overlay hinge mounting plate series: SABAU3R19, and SABAU3R49. The invention can be made of either ABS plastic via injection molding or PLA plastic via 3-D printing. The invention consists of three parts: two guide rails and the main body. The guide rails fit into individual, recessed tracks of the main body and are adjustable so that they may increase or decrease the overall length of the invention, which affects the height of the position of the Salice Overlay hinge mounting plate on the cabinet. The guide rails are secured to their desired positions using four standard nuts and bolts, two in each rail; note, the invention consists of two guide rails, one on either side of the main body, so that the user can fasten mounting plates to either side of a cabinet by simply rotating the invention instead of having to remove a single guide rail and install it onto the other side of the main body. The main body consists of a rigid lip that positions the mounting plate flush with the face frame of the cabinet and, with the assistance of the guide rails, securely holds the plate in place while the user fastens it to the cabinet via guide holes.

1. The invention contains two guide rails designed to lay recessed in separate, parallel tracks of the main body, slide within their respective tracks, and be secured to desired positions to prevent further movement.

2. The center of the main body of the invention is specifically designed to fit to the shape and contours of the Salice Overlay hinge mounting plate series: SABAU3R19, and SABAU3R49.

3. The main body of the invention contains a rigid, immovable edge, parallel to and offset from the guide rails, designed to hold the Salice Overlay hinge mounting plate flush to the edge of the cabinet to which it is being fastened.

4. The main body is contoured to give unobstructed access to the fastener locations of the Salice Overlay hinge mounting plate.
